(19) United States
(12) Patent Application Publication
(10) Pub. No.: US 2019/0107417 A1
(43) Pub. Date: Apr. 11, 2019

(54) FIXING COMPONENT FOR A SENSOR

(71) Applicant: IR-TEC INTERNATIONAL LTD., TAOYUAN CITY (TW)

(72) Inventor: Wen-I HUANG, TAOYUAN CITY (TW)

(21) Appl. No.: 15/856,824

(22) Filed: Dec. 28, 2017

(30) Foreign Application Priority Data
Oct. 11, 2017 (TW) 106214987

(51) Int. Cl. G01D 11/30

(52) U.S. Cl. CPC G01D 11/30

(57) ABSTRACT

A fixing component for a sensor has a main body and two arms. The main body forms a first through hole, and the first through hole extends upward and downward. The two arms are connected on two sides of the main body respectively, an end of each arm distal from the main body forms a through hole. Thus, the arms of the fixing component are bendable so that the fixing component can match a contour of a device and fit perfectly on the device, and a sensor can be fixed on the device. Besides, the fixing component makes the sensor and the device as close as possible, so that the detection environment of the sensor is same with the environment in which the device is located, hence preventing the device from shading a detection scope of the sensor.

### CROSS-REFERENCE TO RELATED APPLICATIONS

This application is based upon and claims priority under 35 U.S.C. 119 from Taiwan Patent Application No. 106214987 filed on Oct. 11, 2017, which is hereby specifically incorporated herein by this reference thereto.

### BACKGROUND OF THE INVENTION

### 1. Field of the Invention

The present invention relates to a fixing component for a sensor, especially to a fixing component that is fixed on a sensor to allow the sensor to be fixed at a specific position.

### 2. Description of the Prior Arts

For enhanced convenience in daily life, many devices are connected to a sensor for detecting changes in the environment and thus the devices can be adjusted according to the changes. Thus, combinations of the devices and the sensor become smart systems or Internet of Things devices. For instance, if a lamp, e.g., a ceiling lamp or a wall lamp, is connected with a sensor which is capable of detecting a position of a human being or a brightness of an environment, the lamp can be turned on, turned off, or adjust luminance in accordance with detection results of the sensor. Most conventional devices do not have any sensor, but, for a purpose of saving energy, a conventional device can be connected with a sensor to control the conventional device and save energy. One common way to arrange a sensor is to electrically connect the sensor and the device that are physically separate from each other. However, this separate arrangement always causes detection conditions of the sensor to be different from an actual environment around the device, or causes the device to shade a detection scope of the sensor and thereby the sensor cannot accurately detect the environment. For example, a ceiling lamp is hung on a ceiling, and a sensor is mounted on the ceiling but is separate from the ceiling lamp, such that a lampshade of the lamp may shade part of a detection scope of the sensor.

To overcome the shortcomings, the present invention provides a fixing component for a sensor to mitigate or obviate the aforementioned problems.

### SUMMARY OF THE INVENTION

The main objective of the present invention is to provide a fixing component for a sensor to fix the sensor on a device through the fixing component.

The fixing component for a sensor has a main body and two arms. The main body has at least one first through hole formed through the main body. The two arms are connected to two sides of the main body respectively. Each one of the two arms has at least one second through hole on an end of said arm, said end distal from the main body.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a fixing component in accordance with the present invention;

FIG. 2 is a perspective view of the fixing component in FIG. 1, showing arms of the fixing component are bent;

FIG. 3 is a top view of the fixing component in FIG. 1, showing the arms are bent;

FIG. 4 is a side view of the fixing component in FIG. 1, showing the arms are bent;

FIG. 5 is a perspective view of the fixing component in FIG. 1, showing the arms and extending portions are bent;

FIG. 6 is a side view of the fixing component in FIG. 1, showing the arms and the extending portions are bent;

FIG. 7 is a perspective view of the fixing component in FIG. 1 combined with a sensor; and

FIG. 8 is a perspective view of the fixing component in FIG. 1 combined with the sensor and further fixed on a device.

### DETAILED DESCRIPTION OF THE PREFERRED EMBODIMENTS

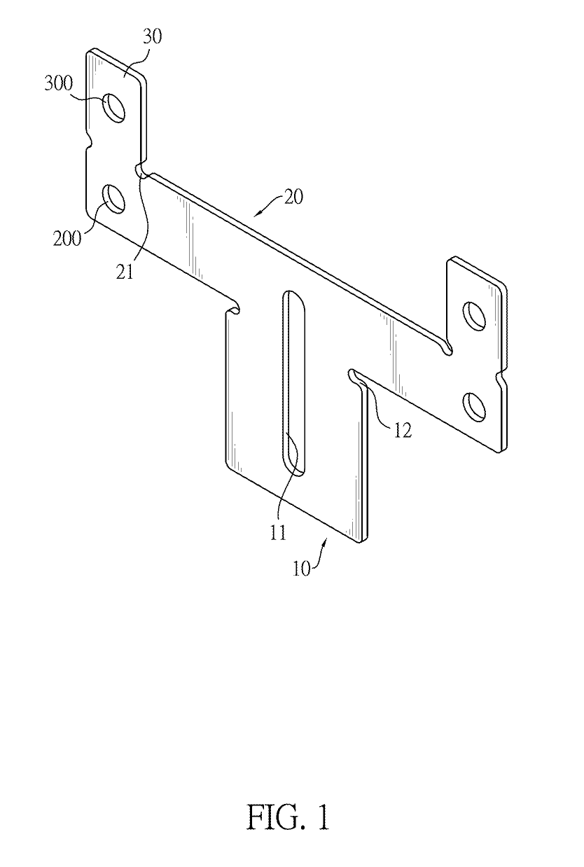

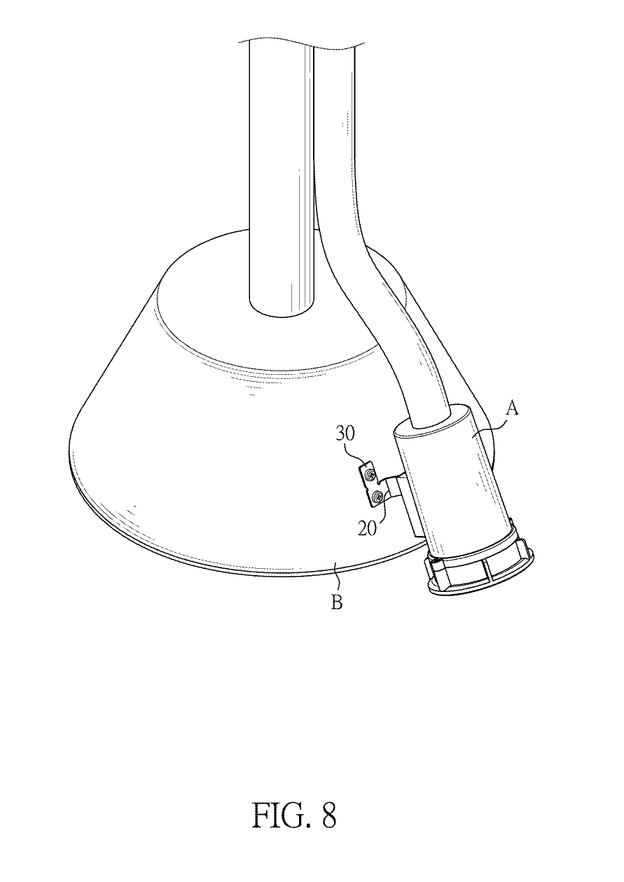

With reference to FIGS. 1 and 8, a fixing component for a sensor A in accordance with the present invention is a sheet that allows the sensor A to be fixed on a device B through the fixing component. The fixing component comprises a main body 10, two arms 20, and two extending portions 30.

The main body 10 forms at least one first through hole 11 and two first notches 12. A number of the at least one first through hole 11 may be one, and the first through hole 11 forms a groove extending upward and downward, or extending leftward and rightward, or being an X-shaped groove. The two arms 20 are connected to two sides of the main body 10 respectively, and, in this embodiment, the two arms 20 protrude leftward or rightward from upper edges of the two sides of the main body 10 respectively. However, the two arms 20 can protrude from middle portions or lower edges of the two sides of the main body 10. The two first notches 12 are on the two sides of the main body 10 and at positions that connect the main body 10 and the two arms 20. In this embodiment, the first notches 12 are adjacent to lower edges of the arms 20.

The two extending portions 30 are connected to the two arms 20 respectively. In this embodiment, each one of the two extending portions 30 is connected to a respective end of the arms 20 and protrudes upward form a respective upper edge of the arms 20, and said end is away from the main body 10. However, in another embodiment, the extending portions 30 may not be formed at the ends of the arms 20 but protrude downward from the lower edges of the arms 20. Each one of the two arms 20 forms two second notches 21 on two edges of the arm 20, and said two edges may be the upper edge and the lower edge. The two second notches 21 are between the end of the arm 20 and the extending portion 30.

Each one of the two arms 20 forms at least one second through hole 200, and each one of the two extending portions 30 fauns at least one third through hole 300. In this embodiment, the second through hole 200 may be on the end of the arm 20, said end distal from the main body 10. In another embodiment, both numbers of the at least one second through hole 200 and the at least one third through hole 300 are one, or the second through hole 200 or the third through hole 300 may be elongated as a groove extending upward and downward, or extending leftward and rightward, or being an X-shaped groove, L-shaped groove, or T-shaped groove.

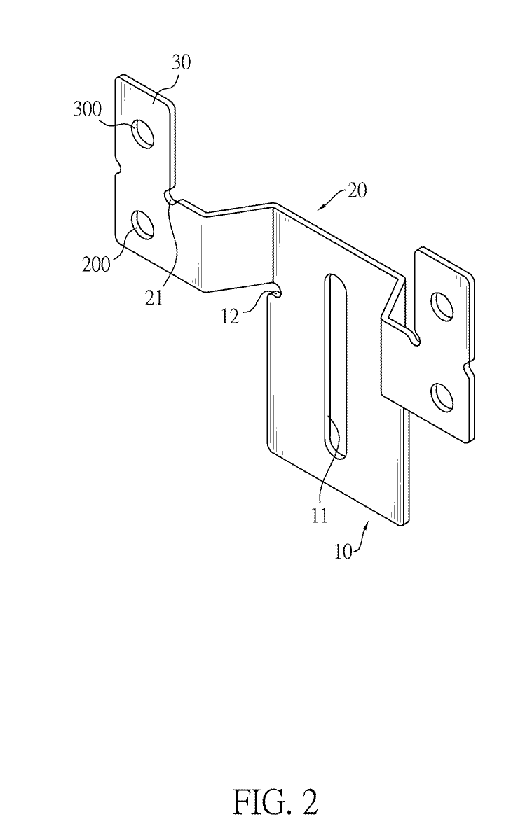

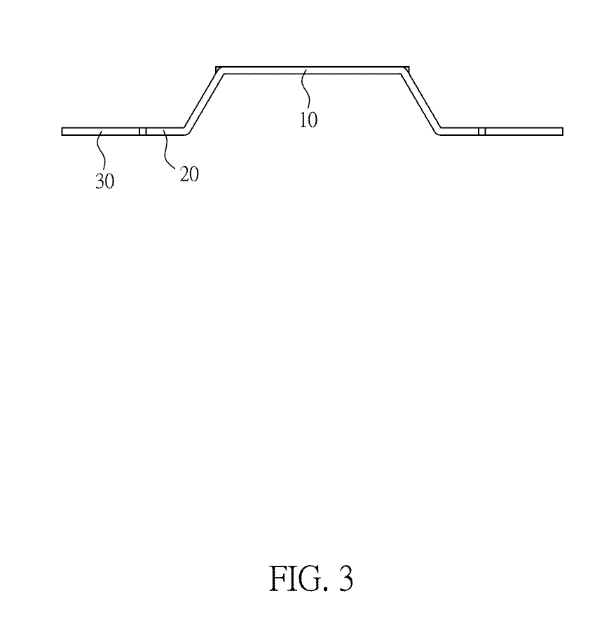

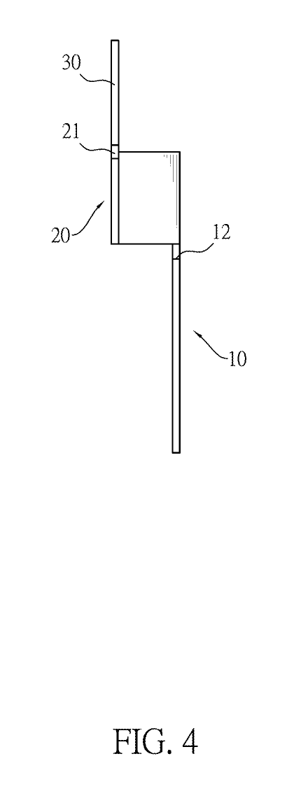

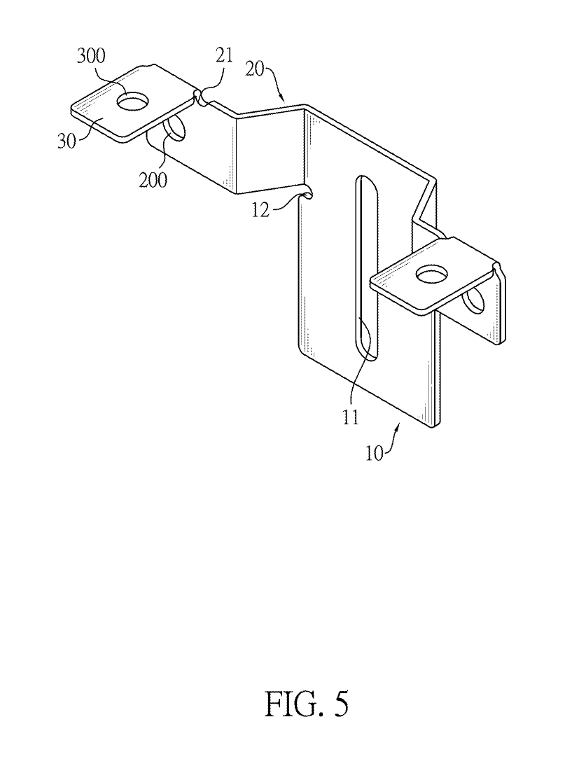

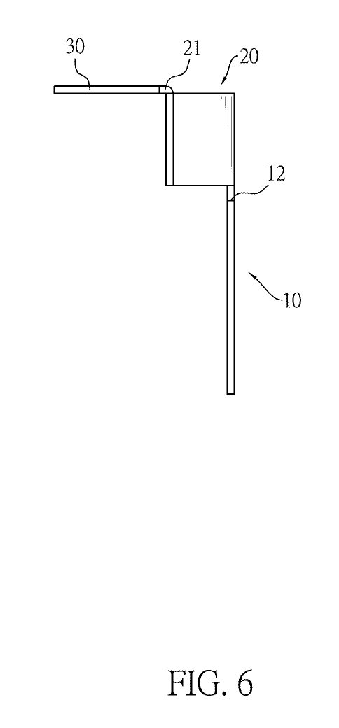

Then refer to FIGS. 2 to 4. To make the fixing component match a contour of the device B that is to be attached with a sensor, the ends of the two arms 20 and the main body 10 may be on different planes. For example, the ends of the two arms 20 and the main body 10 are staggered with respect to each other and on two planes parallel to each other. But, in another embodiment, the two arms 20 and the main body 10 may not be parallel. Then please refer to FIGS. 5 and 6. Similarly, in each one of the two arms 20, there is an angle less than 180 degrees formed between the extending portion 30 and the end of said arm 20. Besides, a user can bend the arms 20 or bend portions between the ends of the arm 20 and extending portions 30 to make the fixing component match the contour of the device B.

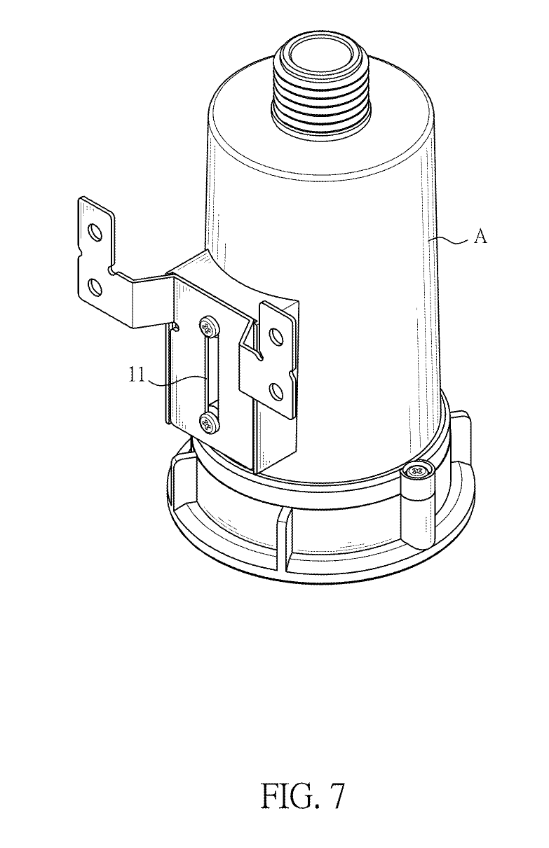

Then please refer to FIGS. 7 and 8. A fixing process of the present invention is mounting a screw through the first through hole 11 of the main body 10 and then screwing the screw on the sensor A for fixing the fixing component and the sensor A first. Precisely, the fixing component may be a fixing component originally shaped as shown in FIG. 1, 2, or 5, or, a fixing component as shown in FIG. 5 which is a fixing component as shown in FIG. 1 whose arms 20 are bent as shown in FIG. 2 and then the ends of the arms 20 are bent as shown in FIG. 5, which makes the fixing component perfectly fit the contour of a shell of the device B. Then, mount screws through the second through holes 200 on the ends of the arms 20 and the third through holes 300 on the extending portions 30 and then screw the screws on the shell of the device B. Thus, a sensor A can be fixed on a device B.

Consequently, with the aforesaid structure, the arms 20 of the fixing component of the present invention can be bent to fit the contour of the device B and thereby a sensor A can be fixed on the device B through the fixing component. Besides, the present invention makes the sensor A and the device B as close as possible, so that the detection environment of the sensor A is same as the environment in which the device B is located, thereby preventing the device B from shading a detection scope of sensor A. For example, as shown in FIG. 8, the sensor A can be mounted on a lampshade of a lamp and a lower end of the sensor A is aligned with a lower edge of the lampshade, which prevents the sensor A from being shaded by the lamp.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A fixing component for a sensor comprising:
a main body comprising
at least one first through hole formed through the main body; and
two arms connected to two sides of the main body respectively; each one of the two arms comprising:
at least one second through hole on an end of said arm, said end distal from the main body.

2. The fixing component as claimed in claim 1, wherein the two aims protrude leftward or rightward from upper edges of the two sides of the main body respectively.

3. The fixing component as claimed in claim 1 further comprising:
two first notches formed on the two sides of the main body respectively and at positions that connect the main body and the two arms.

4. The fixing component as claimed in claim 2 further comprising:
two first notches formed on the two sides of the main body respectively and at positions that connect the main body and the two arms.

5. The fixing component as claimed in claim 1, wherein the at least one first through hole is one in amount, and the first through hole forms:
a groove extending upward and downward, or extending leftward and rightward, or being an X-shaped groove.

6. The fixing component as claimed in claim 4, wherein the at least one first through hole is one in amount, and the first through hole forms:
a groove extending upward and downward, or extending leftward and rightward, or being an X-shaped groove.

7. The fixing component as claimed in claim 1, wherein the at least one second through hole is one in amount, and the second through hole forms:
a groove extending upward and downward, or extending leftward and rightward, or being an X-shaped groove, L-shaped groove, or T-shaped groove.

8. The fixing component as claimed in claim 6, wherein the at least one second through hole is one in amount, and the second through hole forms:
a groove extending upward and downward, or extending leftward and rightward, or being an X-shaped groove, L-shaped groove, or T-shaped groove.

9. The fixing component as claimed in claim 1, wherein the end of each one of the two arms and the main body are staggered with respect to each other.

10. The fixing component as claimed in claim 8, wherein the end of each one of the two arms and the main body are staggered with respect to each other.

11. The fixing component as claimed in claim 1 further comprising:
two extending portions connected to the ends of the two arms, said ends distal from the main body, and each one of the two extending portions forming:
at least one third through hole.

12. The fixing component as claimed in claim 10 further comprising:
two extending portions connected to the ends of the two arms, said ends distal from the main body, and each one of the two extending portions forming:
at least one third through hole.

13. The fixing component as claimed in claim 11, wherein the at least one third through hole is one in amount, and the third through hole forms:
a groove extending upward and downward, or extending leftward and rightward, or being an X-shaped groove, L-shaped groove, or T-shaped groove.

14. The fixing component as claimed in claim 12, wherein the at least one third through hole is one in amount, and the third through hole forms:
a groove extending upward and downward, or extending leftward and rightward, or being an X-shaped groove, L-shaped groove, or T-shaped groove.

15. The fixing component as claimed in claim 11, wherein the extending portion of each one of the two arms protrudes upward from an upper edge of said arm.

16. The fixing component as claimed in claim 14, wherein the extending portion of each one of the two arms protrudes upward from an upper edge of said arm.

17. The fixing component as claimed in claim 11, wherein each one of the two arms further comprises:
two second notches on two edges of said arm respectively and between the end of said arm and the extending portion of said arm.

18. The fixing component as claimed in claim 16, wherein each one of the two arms further comprises:
two second notches on two edges of said arm respectively and between the end of said arm and the extending portion of said arm.

19. The fixing component as claimed in claim 7, wherein each one of the two arms forms:
an angle less than 180 degrees between the extending portion of said arm and the end of said arm.

20. The fixing component as claimed in claim 18, wherein each one of the two arms forms:
an angle less than 180 degrees between the extending portion of said arm and the end of said arm.
